(19) United States
(12) Patent Application Publication
(10) Pub. No.: US 2008/0171579 A1
(43) Pub. Date: Jul. 17, 2008

(54) CELLULAR PHONE WITH SIGNAL LEARNING CAPABILITY

(76) Inventor: David A. Grubek, St. Charles, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/013,718

(22) Filed: Jan. 14, 2008

Related U.S. Application Data
(60) Provisional application No. 60/885,035, filed on Jan. 16, 2007.

(51) Int. Cl. H04M 1/00

(52) U.S. Cl. 455/563; 455/550.1; 455/557

(57) ABSTRACT

A cellular phone which includes a transmitter and receiver (such as a transceiver), an antenna associated with the transceiver, a processor which is operably connected to the transceiver and in communication with memory, and a user interface which is in communication with the processor. The user interface is operable to cause the cellular phone to enter a signal learning mode during which the cellular phone can learn at least one signal which is received via the antenna and transceiver of the cellular phone and store the at least one signal in the memory. The user interface is also operable to cause the cellular phone to enter a signal transmitting mode during which the cellular phone can transmit the at least one signal which was previously received by the cellular phone and stored in memory.

### RELATED APPLICATION (PRIORITY CLAIM)

This application claims the benefit of U.S. Provisional Application Ser. No. 60/885,035, filed Jan. 16, 2007, which is hereby incorporated herein by reference in its entirety.

### BACKGROUND

The present invention generally relates to cellular phones as well as to remote controls.

Presently, cellular phones and remote controls, such as remotes for operating garage door openers, remotes for remote-starting a vehicle, remotes for opening a vehicle door, etc. exist as separate devices. As such, if one is driving up to his or her garage while talking on the cellular phone, he or she has to reach for and operate the garage door opener remote control in order to have the garage door open. This is just one example where having the cellular phone and the remote control be separate devices provides an inconvenience. Another example is in the case where one is approaching his or her car while talking on the cellular phone. Assuming the car door is locked, the person has to locate his or her car keys and operate the remote control in order to unlock the car door and enter the vehicle.

### OBJECTS AND SUMMARY

An object of an embodiment of the present invention is to provide a cellular phone which can double as a remote control.

Another object of an embodiment of the present invention is to provide a cellular phone which can learn at least one remote control signal, and subsequently transmit that signal upon command from a user using a user interface of the cellular phone.

Still another object of an embodiment of the present invention is to provide a cellular phone which can operate as a remote control, regardless of whether the cellular phone is in communication with a cellular phone company's cellular network.

Yet another object of an embodiment of the present invention is to provide a cellular phone which can operate as a remote control, without having to send any signals to a cellular tower.

Briefly, and in accordance with possibly at least one of the foregoing objects, an embodiment of the present invention provides a cellular phone which includes a transmitter and receiver (such as a transceiver), an antenna associated with the transceiver, a processor which is operably connected to the transceiver and in communication with memory in the cellular phone, and a user interface (such as push buttons or a touch screen, for example) which is in communication with the processor.

The cellular phone is configured such that the user interface is operable to cause the cellular phone to enter a signal learning mode during which the cellular phone can learn at least one signal which is received via the antenna and transceiver of the cellular phone and store the at least one signal in the memory. The cellular phone is also configured such that the user interface is operable to cause the cellular phone to enter a signal transmitting mode during which the cellular phone can transmit the at least one signal which was previously received by the cellular phone and stored in memory.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a block diagram of a cellular phone which is in accordance with an embodiment of the present invention; and

FIG. 2 is a block diagram of a method of using the cellular phone shown in FIG. 1, where the method is in accordance with an embodiment of the present invention

### DETAILED DESCRIPTION OF A SPECIFIC EMBODIMENT OF THE PRESENT INVENTION

While the present invention may be susceptible to embodiment in different forms, there is shown in the drawings, and herein will be described in detail, a specific embodiment thereof with the understanding that the present description is to be considered an exemplification of the principles of the invention and is not intended to limit the invention to that as illustrated and described herein.

An embodiment of the present invention provides a cellular phone which is configured to capture or effectively “learn” one or more signals for subsequent transmission. Specifically, the cellular phone is configured such that it can be used not only as a cellular phone for making and receiving calls, but also as, for example, a remote for a garage door opener or a remote keyless entry/remote starter for a vehicle.

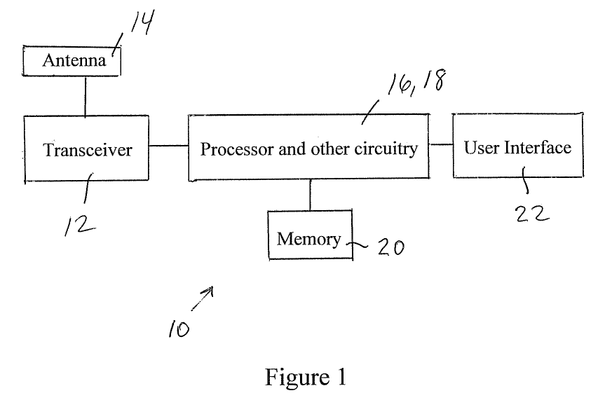

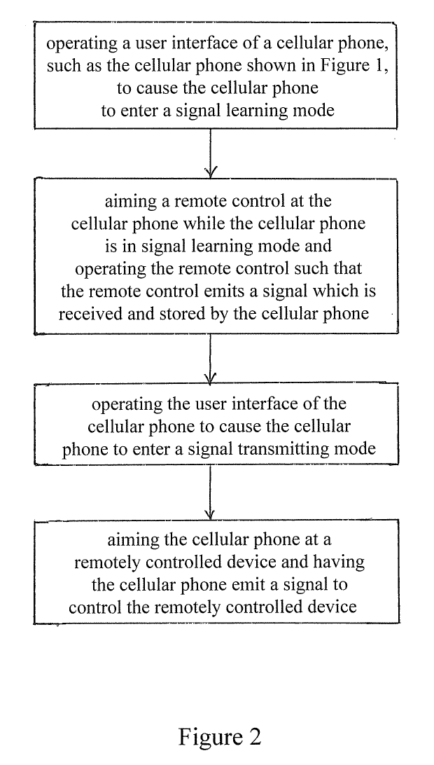

FIG. 1 illustrates the cellular phone 10 in block diagram form, and FIG. 2 illustrates a method of its use. It should be understood that the cellular phone 10 may include additional components not shown in FIG. 1, components not related to the present invention but which are necessary to allow the cellular phone 10 to function as a conventional cellular phone. As shown in FIG. 1, the cellular phone 10 includes a signal transmitter/receiver (i.e., transceiver) 12 and associated antenna 14. The cellular phone 10 also includes a processor 16 which is operably connected to the transceiver 12, as well as other circuitry 18, memory 20 and a user interface such as push keys or a touch screen 22 which enables user operation of the cellular phone 10.

The cellular phone 10, such as the processor 16 thereof, is configured such that the transceiver 12, via the antenna 14, can receive a signal and the processor 16 can store the signal in memory 20 (or information related to the signal which enables the cellular phone 10 to subsequently transmit the signal) for subsequent recall and transmission by the transceiver 12.

In addition to the typical functionality of a conventional cellular phone, the cellular phone 10 shown in FIG. 1 is configured such that the cellular phone 10 can be put in “signal learning mode.” Preferably, the processor 16 of the cellular phone 10 is configured such the cellular phone 10 can be placed in this mode by operating the user interface 22 in a pre-determined manner (as dictated by how the cellular phone is programmed viz-a-viz the processor 16), after which the cellular phone 10 uses the transceiver 12, via the antenna 14, to receive a signal, such as from a garage door opener remote control or a vehicle keyless entry remote control, and store the signal in memory 20. More specifically, once the cellular phone 10 is placed in this mode, a user takes a remote control, such as a remote control for a garage door opener, a remote for a remote starter for a vehicle, etc., and operates the remote while again interfacing with the user interface 22 of the cellular phone 10. This subsequent interaction with the user interface 22 causes the cellular phone to effectively look for a signal from the remote, receive the signal, and store it in memory 20.

Preferably, the cellular phone 10 is configured such that a plurality of such signals can be captured. For example, the cellular phone 10 may be configured to learn and store signals for: opening a garage door, unlocking a vehicle door, locking a vehicle door, opening the trunk of a vehicle, remotely starting a vehicle, etc. as well as possibly signals for operating a television or any other remotely controlled device.

Preferably, the cellular phone 10 is configured such that the cellular phone 10 can thereafter be put in “signal transmission mode.” Preferably, the processor 16 of the cellular phone 10 is configured such the cellular phone 10 can be placed in this mode by operating the user interface 22 in a pre-determined manner (as dictated by how the cellular phone is programmed viz-a-viz the processor 16), wherein the cellular phone 10 uses the transceiver 12, via the antenna 14, to transmit the signal which has been previously received and effectively stored in memory 20. As such, the cellular phone 10 can be used to control remotely controlled devices, such as a garage door opener, the locks of a vehicle, the ignition of a vehicle, etc.

As such, the cellular phone 10 is configured such that it can be put in signal learning mode during which it can capture or effectively “learn” one or more signals, such as by placing the cellular phone 10 in signal learning mode and pointing a remote control (such a remote for operating a garage door opener or a keyless entry remote) in the general direction of the antenna 14 of the cellular phone 10 and operating the remote. In this mode, the cellular phone 10 receives the signal and the processor 16 stores the signal in memory 20 (or information related to the signal such that the cellular phone 10 can use the information to later transmit the signal). Subsequently, the cellular phone 10 can be put in signal transmission mode, during which it can transmit one or more of the signals which have been previously captured or “learned.” Therefore, the cellular phone 10 not only works as a typical cellular phone, but also doubles as a remote control, such as a remote control for a garage door opener, as a vehicle keyless entry remote/remote starter, or as any other remote which transmits signals to a remotely controlled device.

Preferably, the cellular phone 10 is configured such that it can effectively operate as a remote control, regardless of whether the cellular phone is in communication with a cellular phone company's cellular network and without having to send any signals to a cellular tower. In other words, the cellular phone 10 communicates directly with the remotely controlled device. As such, the present invention can possibly render old, inactive cellular phones useful—as programmable remote controls (assuming the cellular phones are in accordance with an embodiment of the present invention and can learn signals for subsequent transmission).

In the above description, the user interface 22 was described as either being push keys or a touch screen. However, the user interface 22 may take many other forms. For example, the cellular phone 10 may be configured such that it is voice-activated (in which case the user interface would include a microphone of the cellular phone 10).

The memory 20 can also take a plurality of different forms. For example, the memory 20 can be hard memory which is in the cellular phone 10, or can be removable flash memory for example.

Still further, the transceiver 12 can be provided as being a transmitter and a receiver both, or the transmitter and receiver can be provided as being separate devices, possibly having different antennas or sharing the same antenna.

Furthermore, while it was described hereinabove that the cellular phone 10 stores the signal in memory 20, this should not be construed narrowly to require that the cellular phone 10 stores the actual signal in memory 20. Instead, the processor 16 (and/or circuitry 18 or other components of the cellular phone 10) may be configured to analyze the signal and store certain information in the memory 20 such that the processor 16 can thereafter use that information to re-produce the signal (or at least a similar signal which is as effective at operating the device intended).

Finally, the type of signal(s) which the cellular phone 10 is configured to receive can vary. For example, the cellular phone 10 can be configured to receive and store radio frequency signals, in which case the transceiver 12 would be provided as being a radio frequency transceiver and the cellular phone 10 would be structured accordingly. Alternatively (or additionally), the cellular phone 10 can be configured to learn and transmit other types of signals, such as infrared signals in which case the transceiver 12 would be provided as being an infrared transceiver (or a separate transmitter and receiver) and the cellular phone 10 would be structured accordingly.

In light of the fact that different embodiments of the present invention can vary greatly in structure and form, while a specific embodiment of the present invention is shown and described herein, it is envisioned that those skilled in the art may devise various modifications without departing from the spirit and scope of the present invention.

What is claimed is:

1. A cellular phone which is configured to learn and transmit a signal, said cellular phone comprising: a transceiver; an antenna associated with the transceiver; memory; a processor which is operably connected to the transceiver and in communication with the memory; and a user interface which is in communication with the processor, wherein the processor of the cellular phone is configured such that the user interface is operable to cause the cellular phone to enter a signal learning mode during which the cellular phone can learn at least one signal which is received via the antenna and transceiver of the cellular phone and store the at least one signal in the memory.

2. A cellular phone as recited in claim 1, wherein the processor of the cellular phone is configured such that the user interface is operable to cause the cellular phone to enter a signal transmitting mode during which the cellular phone can transmit the at least one signal which was previously received by the cellular phone and stored in memory.

3. A cellular phone as recited in claim 1, wherein the transceiver comprises at least one of a radio frequency transceiver and an infrared transceiver.

4. A cellular phone as recited in claim 1, wherein the transceiver comprises a radio frequency transceiver, and wherein the processor of the cellular phone is configured such that the user interface is operable to cause the cellular phone to enter a radio frequency signal learning mode during which the cellular phone can learn at least one radio frequency signal which is received via the antenna and radio frequency transceiver of the cellular phone and store the at least one radio frequency signal in the memory, and wherein the processor of the cellular phone is configured such that the user interface is operable to cause the cellular phone to enter a radio frequency signal transmitting mode during which the cellular phone can transmit the at least one radio frequency signal which was previously received by the cellular phone and stored in memory

5. A cellular phone as recited in claim 1, wherein the user interface comprises at least one of push keys and a touch screen.

6. A cellular phone as recited in claim 1, wherein the transceiver comprises a transmitter and a receiver which are separate devices.

7. A cellular phone as recited in claim 1, wherein the processor is configured such that the cellular phone can learn and store a plurality of signals in memory.

8. A cellular phone as recited in claim 1, wherein the processor is configured such that the cellular phone can learn and store a plurality of radio frequency signals in memory.

9. A cellular phone as recited in claim 1, wherein the processor is configured such that the cellular phone can learn and store a plurality of infrared signals in memory.

10. A cellular phone as recited in claim 1, wherein the memory comprises hard memory in the cellular phone.

11. A cellular phone as recited in claim 1, wherein the memory comprises removable flash memory.

12. A cellular phone as recited in claim 1, wherein the cellular phone is configured to be voice-activated.

13. A method of using a cellular phone which is configured to learn and transmit a signal, said method comprising:
deploying the cellular phone, wherein the cellular phone comprises a transceiver, an antenna associated with the transceiver, memory, a processor which is operably connected to the transceiver and in communication with the memory, and a user interface which is in communication with the processor; and
operating the user interface of the cellular phone to cause the cellular phone to enter a signal learning mode during which the cellular phone can learn at least one signal which is received via the antenna and transceiver of the cellular phone and store the at least one signal in the memory.

14. A method as recited in claim 13, further comprising aiming a remote control at the cellular phone while the cellular phone is in signal learning mode and operating the remote control such that the remote control emits a signal which is received and stored by the cellular phone.

15. A method as recited in claim 13, further comprising operating the user interface of the cellular phone to cause the cellular phone to enter a signal transmitting mode during which the cellular phone can transmit the at least one signal which was previously received by the cellular phone and stored in memory.

16. A method as recited in claim 15, further comprising aiming the cellular phone at a remotely controlled device while the cellular phone is in signal transmission mode.

17. A method as recited in claim 13, further comprising operating the user interface of the cellular phone to cause the cellular phone to store a plurality of radio frequency signals in memory.

18. A method as recited in claim 17, further comprising operating the user interface of the cellular phone to cause the cellular phone to transmit one of the radio frequency signals which are stored in memory.

19. A method as recited in claim 13, wherein the method comprises operating the user interface of the cellular phone to cause the cellular phone to enter a radio frequency signal learning mode during which the cellular phone can learn at least one radio frequency signal which is received via the antenna and transceiver of the cellular phone and store the at least one radio frequency signal in the memory.

20. A method as recited in claim 19, further comprising operating the user interface of the cellular phone to cause the cellular phone to enter a radio frequency signal transmitting mode during which the cellular phone can transmit the at least one radio frequency signal which was previously received by the cellular phone and stored in memory.
